(19) United States
(12) Patent Application Publication
(10) Pub. No.: US 2005/0067824 A1
(43) Pub. Date: Mar. 31, 2005

(54) Knee bolster apparatus of vehicle

(76) Inventor: In Gyu Kim, Hwaseong-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/750,685

(22) Filed: Dec. 31, 2003

(30) Foreign Application Priority Data
Sep. 30, 2003 (KR) 10-2003-0067812

(51) Int. Cl. B60R 21/045

(52) U.S. Cl. 280/752

(57) ABSTRACT

A knee bolster apparatus comprises a knee bolster plate mounted on a instrument panel. A supporting frame transversely extends through an inner space of the instrument panel and includes a supporting bracket secured to the supporting frame and disposed to be opposite to the instrument panel. The supporting bracket is shaped as an “S” as a single body such that the supporting bracket is relatively light weight and improves the efficiency of production and the performance requirement regarding strength and buffering of an occupants knees.

### CROSS-REFERENCE TO RELATED APPLICATIONS

This application claims priority of Korean Application No. 10-2003-0067812, filed on Sep. 30, 2003, the disclosure of which is incorporated fully herein by reference.

### FIELD OF THE INVENTION

Generally, the present invention relates to a knee bolster apparatus of a vehicle. More particularly the knee bolster apparatus includes a supporting bracket with improved assembling efficiency and an appropriate degree of strength.

### BACKGROUND OF THE INVENTION

Generally, a knee bolster apparatus is a part of vehicle that is mounted near the instrument panel such that, in case of a front collision impact, the apparatus functions as a buffer and protects the occupant's knee.

Typically, a knee bolster plate is mounted on the instrument panel of the vehicle and is supported by a bracket assembly. The bracket assembly typically includes a primary bracket and an auxiliary bracket. The bracket assembly is generally secured to a supporting frame that is connected to the vehicle body.

A primary bracket is typically shaped as a “U” and the auxiliary bracket interconnects two extending portions of the primary bracket for reinforcing the strength of the bracket assembly. The knee bolster plate, the instrument panel, and the bracket assembly are then connected to each other with conventional connecting means such as bolt-nut connections.

However, because the conventional bracket assembly, such as that described above, has a structure including the primary bracket and auxiliary bracket, a complicated process is required for producing the bracket assembly. Furthermore, when the auxiliary bracket breaks, the bracket assembly can not maintain appropriate strength and function as a buffer for the occupants knees.

### SUMMARY OF THE INVENTION

An exemplary knee bolster apparatus of a vehicle comprises a knee bolster plate mounted on a instrument panel. The apparatus also includes a supporting frame transversely extending through an inner space of the instrument panel and a supporting bracket secured to the supporting frame and disposed to be opposite to the instrument panel. The supporting bracket is shaped as an “S” as a single body.

Preferably, the supporting bracket comprises a semicircular hook portion connected to the supporting frame. A first connecting portion extends approximately vertically down from the semicircular hook portion and a second connecting portion extends upwardly from the first connecting portion to near the knee bolster plate with an inclination of a first predetermined angle. A supporting portion extends downward toward the supporting frame from the second connecting portion with an inclination of a second predetermined angle.

### BRIEF DESCRIPTION OF THE DRAWINGS

FIG. 1 is a perspective view of a knee bolster apparatus according to an embodiment of the present invention; and

FIG. 2 is a side sectional view of the knee bolster apparatus of FIG. 1.

### DETAILED DESCRIPTION OF A PREFERRED EMBODIMENT

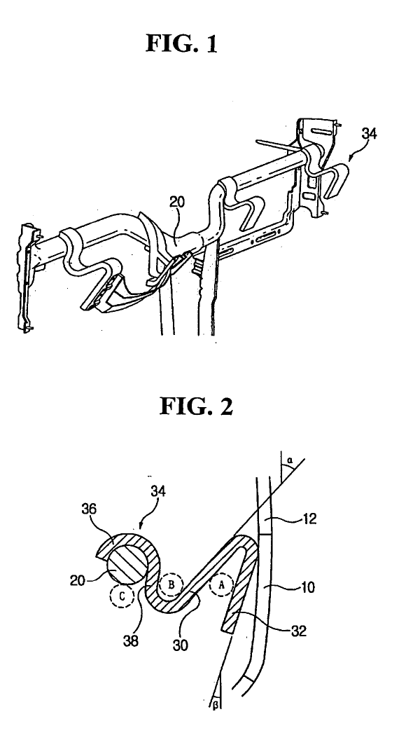

As shown in FIGS. 1 and 2, a supporting bracket 34 is disposed between a supporting frame 20, which transversely extends through the inner space of the instrument panel 12, and a knee bolster plate 10 mounted on the instrument panel 12. The supporting bracket 34 is shaped approximately as an “S” in a single body. According to an embodiment, the supporting bracket 34 can be divided into a plurality of portions defined as a semicircular hook portion 36, a first connecting portion 38, a second connecting portion 30, and a supporting portion 32. The semicircular hook portion 36 is secured to a supporting frame 20 such that the supporting bracket 34 is supported by the supporting frame 20.

The first connecting portion 38 extends approximately vertically downward from the semicircular hook portion. The second connecting portion 30 extends upwardly from a bottom end of the first connecting portion 38 to near the knee bolster plate 10 with an inclination of a first predetermined angle. The first predetermined angle is defined as an angle between a vertical line and the second connecting portion 30, and is denoted as “α” in FIG. 2.

The supporting portion 32 extends downward toward the supporting frame 20 with an inclination of a second predetermined angle. The second predetermined angle is also defined as an angle between a vertical line and the supporting portion 32 and is denoted as “β” in FIG. 2.

The supporting portion 32 supports the knee bolster plate 10 at its upper portion and the remaining portion of the supporting portion 32 does not touch the knee bolster plate 10. Therefore, a space for buffering an impact, transferred through the knee bolster plate 10, is assured.

The first predetermined angle “α” is formed to be greater than the second predetermined angle “β” such that a first buffer space denoted as “A” is formed between the supporting portion 32 and the second connecting portion 30. Furthermore, a second buffer space denoted as “B” is formed between the first connecting portion 38 and the second connecting portion 30 and a third buffer space denoted as “C” is formed between the supporting frame 20 and the first connecting portion 38.

Accordingly, the supporting bracket 34 takes on a shape as an “S” such that an impact transferred through the knee bolster plate 10 is buffered by gradations while collapsing the supporting bracket 34. Thereby, damage to the knees of an occupant is minimized. A result of an impact test of a vehicle provided with a knee bolster apparatus as described above is shown in the table below.

| | |
|---|---|
| Driver's seat | Passenger's seat |

| | Left | Right | Left | Right |
|---|---|---|---|---|
| Femur Load(N) | 8743 | 8776 | 4912 | 4201 |
| Permeation(mm) | 114.3 | 55.9 | 100.2 | 110.2 |

The test was undertaken with FMVSS 208 motor vehicle safety standards, which specify performance requirements for occupant protection. The impact pulse was selected as AAMA Sled Test Pulse. The supporting bracket 34 was formed with steel with a density is 7.85E-6 (kg/mm³) and a yield strength is 0.124 (Gpa). The performance requirement regarding a knee bolster apparatus is that a load applied to the femur should be less than about 10,000N, and an amount of permeation should be less than about 120 mm. As shown in the table, the knee bolster apparatus satisfies the requirement described above in both the driver's seat and the passenger's seat.

According to the bolster apparatus of this invention, it is possible to make a knee bolster apparatus which is relatively light weight and improves the efficiency of production. Furthermore, the performance requirement regarding strength and buffering can be satisfied.

1. A knee bolster apparatus of a vehicle, comprising:
a knee bolster plate mounted on an instrument panel;
a supporting frame transversely extending through an inner space of the instrument panel; and
a supporting bracket secured to the supporting frame and disposed to be opposite to the instrument panel,
wherein the supporting bracket is shaped as an “S” as a single body.

2. The knee bolster apparatus of claim 1, wherein the supporting bracket comprises:
a semicircular hook portion connected to the supporting frame;
a first connecting portion extending approximately vertically down from the semicircular hook portion;
a second connecting portion extending upwardly from the first connecting portion to near the knee bolster plate with an inclination of a first predetermined angle; and
a supporting portion extending downwardly toward the supporting frame from the second connecting portion with an inclination of a second predetermined angle.
